(19) United States
(12) Patent Application Publication
(10) Pub. No.: US 2010/0191658 A1
(43) Pub. Date: Jul. 29, 2010

(54) Predictive Engine for Interactive Voice Response System

(76) Inventors: Pallipuram V. Kannan, Los Gatos, CA (US); Mohit Jain, Bangalore (IN); Ravi Vijayaraghavan, Mountain View, CA (US)

Correspondence Address: GLENN PATENT GROUP, 3475 EDISON WAY, SUITE L, MENLO PARK, CA, 94025, US

(21) Appl. No.: 12/693,236

(22) Filed: Jan. 25, 2010

Related U.S. Application Data
(60) Provisional application No. 61/147,370, filed on Jan. 26, 2009.

(51) Int. Cl. G06Q 10/00; G10L 13/00; G10L 15/26

(52) U.S. Cl. 705/304; 704/262; 704/235; 704/E13.001; 704/E15.001

(57) ABSTRACT

A customer service issue prediction engine uses one or more models of issue probability. A method of multi-phase customer issue prediction includes a modeling phase, an application phase, and a learning phase. A telephonic interactive voice response (IVR) system predicts customer issues.

### CROSS REFERENCE TO RELATED APPLICATIONS

This patent application claims the benefit of U.S. provisional patent application Ser. No. 61/147,370, Predictive Engine for Interactive Voice Response System, filed Jan. 26, 2009, the entirety of which is incorporated herein by this reference thereto.

### BACKGROUND OF THE INVENTION

1. Technical Field

The invention relates generally to the field of interactive voice response systems. More specifically, the invention relates to prediction of customer issues in an interactive voice response system based on customer attributes and one or more models of issue probability.

2. Description of the Related Art

Customer service management traditionally includes interaction between a customer and a customer service agency. Interaction between the customer and the customer service agency has traditionally been in the form of a human to human conversation conducted over the phone or in real-time text chat. However, interactive voice response (IVR) systems have become more and more commonplace.

One shortcoming present in existing interactive voice response systems is that customers tend to become annoyed or frustrated with level upon level of questioning from the IVR system to determine the customer's purpose for calling. Customer frustration frequently leads to the customer ending the session early, thereby souring the customer's impression of the products or the company.

Current interactive voice response technologies do not adequately address these shortcomings. Instead, known IVR systems base the options they provide to callers on generalizations and, oftentimes, inaccurate assumptions.

### SUMMARY OF THE INVENTION

The invention relates to a customer service issue prediction engine that uses customer attributes and one or more models of issue probability to predict customer issues in future IVR interactions. Some embodiments of the invention provide a multi-phase customer issue prediction technique that includes a modeling phase, an application phase, and a learning phase.

In some embodiments of invention, the modeling phase uses historical customer service data to build one or more models of customer service issue probability. The application phase uses in-call customer service input and the one or more models of customer service issue probability to predict why a customer is presently contacting the customer service agency. The learning phase determines whether the prediction was accurate and readjusts the models accordingly.

In the presently preferred embodiments of the invention, the Naïve Bayes algorithm is used to model customer service issue probability.

Some embodiments of the invention use a telephonic interactive voice response (IVR) system to predict customer issues. Some other embodiments use web-based or cellular network-based IVR systems.

A plurality of server-based networking architectures are presented that include an IVR system for carrying out issue prediction. In some embodiments of the invention, an issue prediction engine is employed in a web-accessed customer service response system. According to these embodiments, the web-accessed customer service response system uses a decision engine to determine and predict customer service issues, queries, and problems.

Some embodiments of the invention are extended to other communication channels, such as web-chat, instant messaging, voice over internet protocol (VoIP), mobile device communication formats (i.e. SMS, MMS, etc.), and other communication channels, now known or later developed. In any communication environment, the predictive engine provides the same type of useful information to customer service agencies as in the IVR system.

In the case of web-chat, the predictive engine delivers useful information to a customer service agency for providing web-based issue resolution. In some embodiments of the invention, a proactive chat invitation can pop up if someone is browsing a customer service website and the prediction engine determines that the customer is in need of assistance.

In some embodiments of the invention, the prediction engine delivers a chat invitation to the customer along with providing the customer service agent with tools for resolving predicted customer issues. In some embodiments, the results of this prediction are passed on to the chat customer service agent to help the agent identify the most likely reasons for customer contact, thereby increasing the agent's productivity. In another scenario, the prediction engine provides the customer service agent with pre-scripted resolutions to the predicted issues. In some other embodiments, the prediction results gives customer service agents access to an intelligent knowledge database containing relevant tools to assist the agent in resolving the customer's issues.

### BRIEF DESCRIPTION OF THE DRAWINGS

FIG. 1A illustrates a system of customer interaction with an IVR system according to the presently preferred embodiments of the invention;

FIG. 1B illustrates an example of a dynamic IVR architecture according to some embodiments of the invention;

FIG. 1C illustrates examples of server-based IVR system configurations in a distributed network environment according to some embodiments of the invention;

FIG. 2 illustrates a method of improving customer satisfaction in an interactive voice response system comprising a modeling phase, an application phase, and a learning phase according to some embodiments of the invention;

FIG. 3 illustrates a method of improving customer satisfaction in an interactive voice response system according to some embodiments of the invention; and

FIG. 4 illustrates a method of web-accessed customer service using a decision engine according to some embodiments of the invention.

FIG. 5 is a block schematic diagram of a machine in the exemplary form of a computer system within which a set of instructions may be programmed to cause the machine to execute the logic steps of the invention.

### DETAILED DESCRIPTION OF THE INVENTION

### Interactive Voice Response System and Methods

The invention relates to prediction of customer issues in an interactive voice response (IVR) system based on one or more models of issue probability.

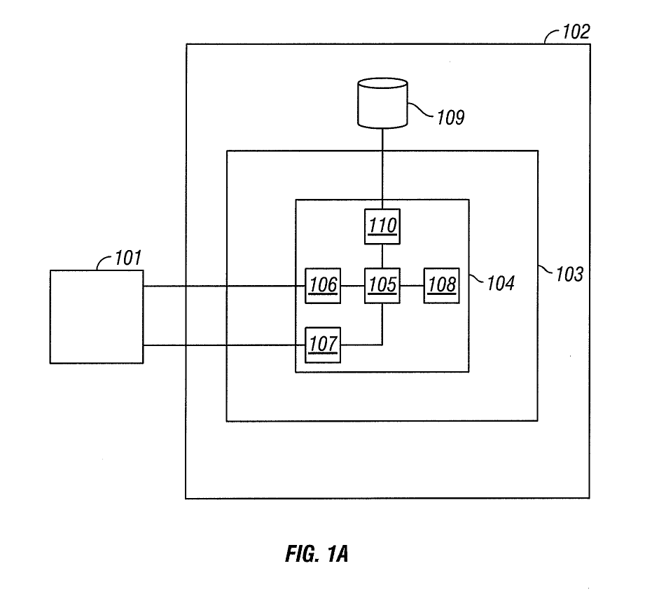

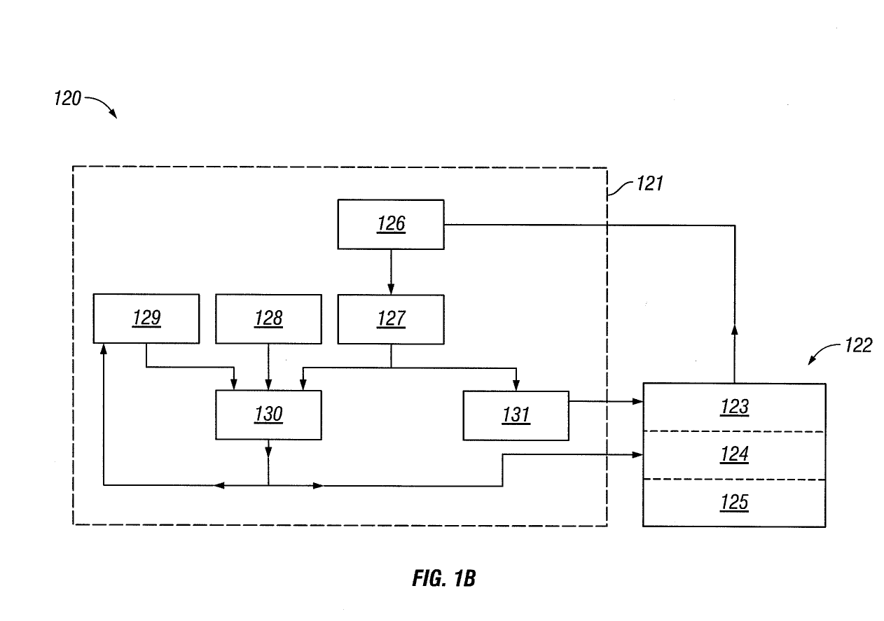

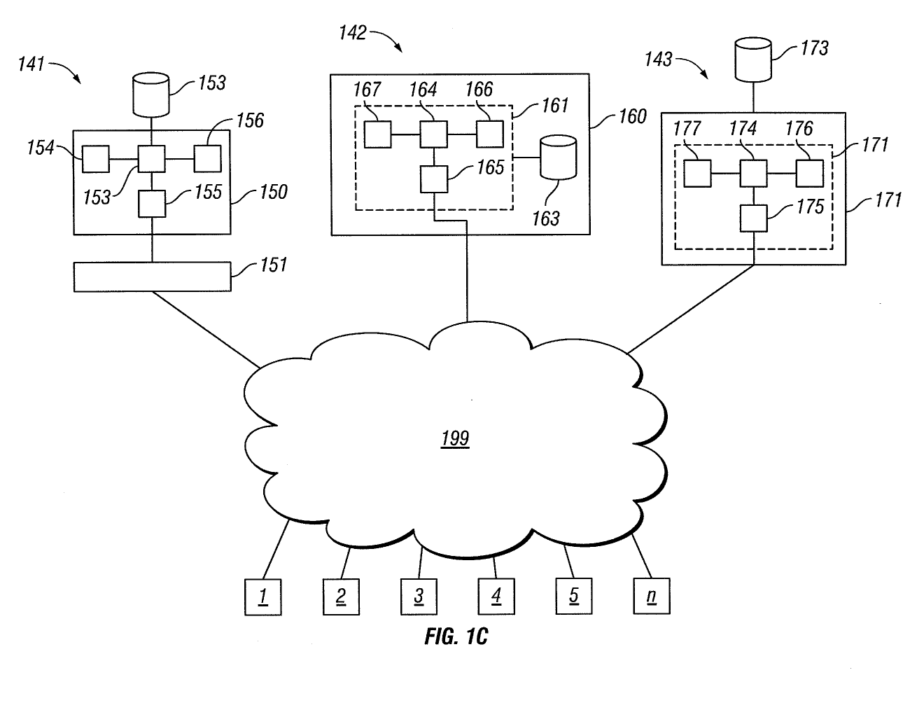

FIG. 1A illustrates the basic system of customer interaction with the IVR system according to the presently preferred embodiments of the invention. According to FIG. 1, a customer 101 contacts a customer service agency 102 that uses an IVR system 103. The IVR system 103 includes an IVR prediction engine 104 which includes a processor 105, a voice detection unit 106, an audio response unit 107, a modeling module 100, and a memory 108. The IVR prediction engine 104 is also operatively coupled with a database 109 containing historical customer records.

The IVR prediction engine 104 ingests historical customer data from the database 109 via a modeling module 110. The modeling module 110 processes the historical customer data and creates one or more models of issue probability to predict future customer issues, as explained in greater detail below.

A customer contacts the IVR system with one or more issues and initiates an IVR session. The IVR system collects data from a customer 101 via the voice detection unit 106 during the IVR session. The IVR prediction engine 104 then uses the one or more models of issue probability and the collected customer data to predict what the customer 101 is calling about. The IVR prediction engine 104 makes predictions based on the previously built models of probability. Once a prediction is made about what issue the customer is likely calling about, the IVR prediction engine presents IVR options to the customer via the audio response unit 107.

The IVR system is configured to handle customer service queries, problems, issues, etc. from a variety of sources. For example, in the presently preferred embodiments of the invention, the IVR system is configured to collect queries, problems, issues, etc. from a telephonic IVR platform, a website, and a plurality of mobile devices. FIG. 1B illustrates an example of a dynamic IVR architecture 120 according to some embodiments of the invention.

The dynamic IVR architecture 120 comprises an IVR system 121 and a plurality of customer access platforms 122 including a telephonic IVR platform 123, a website 124, and one or more mobile devices 125.

The IVR system 121 uses an identity management system 126 to ingest one or more customer identity attributes from one or more of the customer access platforms 122. The identity management system 126 associates the one or more customer identity attributes with a customer identity identifier. The customer identity identifier is sent along with the one or more customer identity attributes to a decision engine 127. The decision engine 127 processes the one or more attributes, and determines which IVR options are most important to the customer, as explained in greater detail below.

In some embodiments of the invention, the one or more customer access platforms 122 have been previously enabled with a hardware or software decision engine reader application. According to these embodiments, the decision engine reports options to the one or more customer access platforms 122 based on the decision engine's results via an options plug-in 131.

In some embodiments of the invention, the decision engine 127 uses historical customer service transactions for the collective user-base to make its decisions. According to these embodiments, the IVR system 121 includes a collective-user transaction history store 128. In some embodiments of the invention, the decision engine 127 uses user-specific preferences to make decisions. According to these embodiments, the IVR system 121 includes a user-specific preference store 129. The decision engine accesses the user-specific preference store using the customer identity identifier. In some other embodiments of the invention, the decision engine 127 uses historical customer service transactions for the collective user-base and user-specific preferences to make its decisions. According to these embodiments, the IVR system 121 includes both a collective-user transaction history store 128 and a user-specific preference store 129.

In some embodiments of the invention, the IVR system 121 includes a self-serve options wizard 130 to supplement the options plug-in 131 or to create a base level of attributes for the system.

The dynamic IVR architecture 120 can be configured in a plurality of computing environments. For example, in some embodiments of the invention, the IVR system is part of a server-based distributed computer environment. FIG. 1C illustrates examples of server-based IVR system configurations in a distributed network environment according to some embodiments of the invention.

FIG. 1C includes three examples of IVR configurations 141, 142, and 143 operatively coupled with a network 199. Each of the IVR configurations 141, 142, and 143 connect with a plurality of users 1, 2, 3, 4, 5, . . . , n.

The first configuration 141 comprises an IVR system 150 coupled with a server 151 and a database 152. The IVR system 150 includes a processor 153, a memory 154 coupled with the processor 153, a network interface 155 coupled with the processor 153, and a prediction engine 156 coupled with the processor 153.

A second configuration 142 comprises server-based IVR system 160. The server-based IVR system includes an IVR processing module 161 coupled with a server-based database 163. The IVR processing module 161 includes a processor 164, a memory 167 coupled with the processor 164, a network interface 165 coupled with the processor 164, and a prediction engine 166 coupled with the processor 164.

A third configuration 143 comprises a server-based IVR system 170. The server-based IVR system includes an IVR processing module 171 coupled with a remote database 173. The IVR processing module 171 includes a processor 174, a memory 177 coupled with the processor 174, a network interface 175 coupled with the processor 174, and a prediction engine 176 coupled with the processor 174.

### Multi-Phase Prediction Method

In the presently preferred embodiments of the invention a multi-phase customer issue prediction method is employed to improve customer satisfaction in an interactive voice response system by predicting customer issues during the interactive voice response session. The multi-phase customer issue prediction method includes a modeling phase, an application phase, and a learning phase.

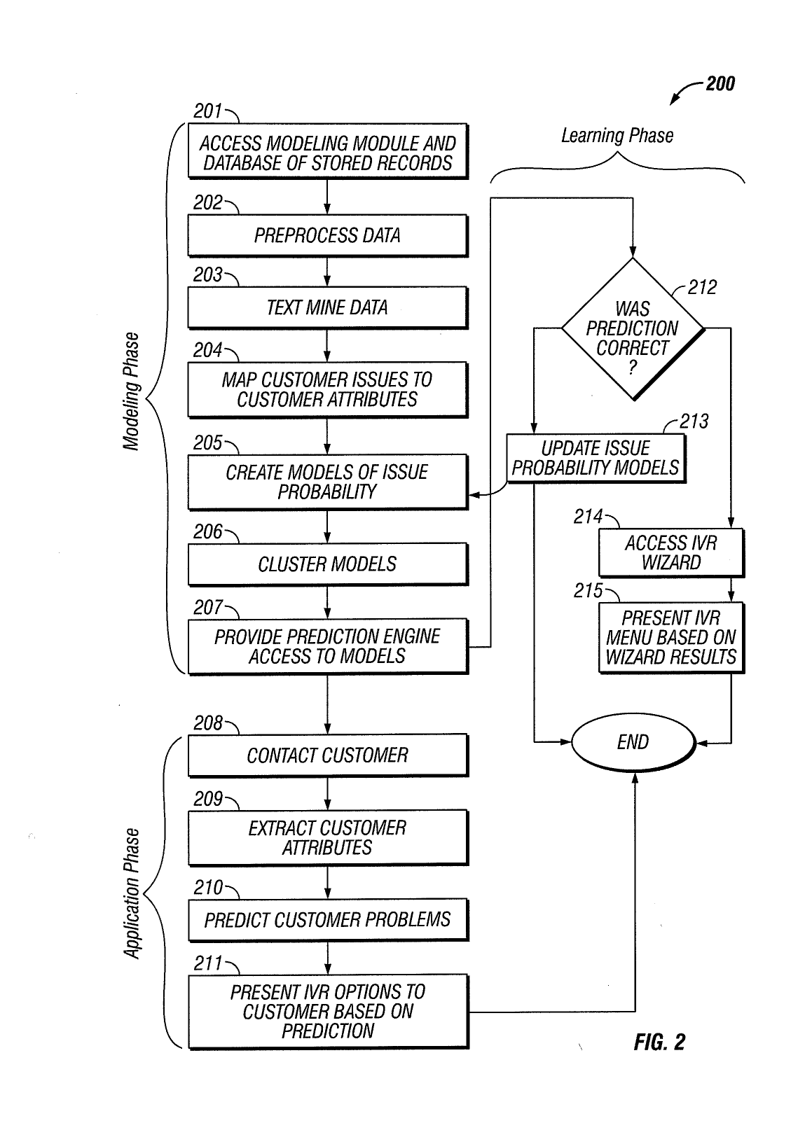

FIG. 2 illustrates a method of improving customer satisfaction 200 in an interactive voice response system comprising a modeling phase, an application phase, and a learning phase.

The method 200 begins in the modeling phase by accessing the modeling module and historical customer records from one or more databases 201. Customer records include, but are not limited to customer-agent interaction data, customer relationship management (CRM) data, customer geographical data, customer demography based information, voice recordings, call quality data, disposition data, verbatim notes, survey data, community data, industry data, customer history, ACSI Index information, a customer loyalty metric such as a Net Promoter Score, a score from J.D. Power and Associates, data from online forums, data from blogs, data from short message format personal media feeds, and combinations thereof.

In some embodiments of the invention, the accessed data is pre-processed 202 into a common format. For example, in some embodiments of the invention, customer-agent voice interaction data is pre-processed with a voice to text application. The pre-processed data is then data-mined 203 to pick out historical issue data asked for by a customer, and historical data relating to that customer's attributes. An example of a historical data relating to a customer service issue is an instance of a caller asking how to operate a smartphone. An example of a historical customer attribute is the fact that that particular customer called using a home phone and voice over internet protocol (VoIP).

The method 200 continues by mapping the historical customer issues to the historical customer attributes 204. Referring to the above example, such mapping would include mapping the smartphone operation issue to the VoIP phone user. Next, one or more models are created 205 to predict what issues future users with a given set of attributes will call an IVR system about.

In some embodiments of the invention, the Naïve Bayes Algorithm is employed to build a prediction model, as explained below. A Bayes classifier is a simple probabilistic classifier based on applying Bayes' theorem (from Bayesian statistics) with strong (naive) independence assumptions. In simple terms, a naive Bayes classifier assumes that the presence (or absence) of a particular feature of a class is unrelated to the presence (or absence) of any other feature.

Depending on the precise nature of the probability model, naive Bayes classifiers can be trained very efficiently in a supervised learning setting. In spite of their naive design and apparently over-simplified assumptions, naive Bayes classifiers have worked quite well in many complex real-world situations. An advantage of the naive Bayes classifier is that it requires a small amount of training data to estimate the parameters (means and variances of the variables) necessary for classification.

In some embodiments of the invention, pluralities of models are created. According to these embodiments, the method 200 includes a step of clustering the plurality of models 206. Once the one or more models of issue probability are built and clustered, the models are made accessible 207 by the prediction engine for use in the application phase.

The application phase begins with a customer contacting the IVR system 208 with one or more customer service issue, problem, query, question, comment, feedback, etc. The IVR system then extracts one or more customer attribute about the customer 209. Using the extracted attributes and the models of probability, the method 200 predicts 210 at least one issue of the current customer. The application phase then presents IVR options to the customer based on the at least one predicted issue 211.

The method of improving customer satisfaction 200 in an interactive voice response system optionally includes a learning phase. The learning phase first determines whether the one or more models of prediction are correct 212. In some embodiments of the invention the determination of whether the issue prediction correctly identified one or more issue of a customer is performed by the interactive voice response system by explicitly asking the customer if the one or more issue prediction was correct during said interactive voice response session.

In some other embodiments of the invention, the determination of whether the issue prediction models correctly identified the issue of the customer is performed implicitly by inferring that the issue prediction was correct when the customer continues the interactive voice response session after being presented with interactive voice response options based on the issue prediction.

If the step of predicting customer issues is deemed to have been made correctly, the method 200 continues by updating the issue probability models 213. In some embodiments, updating the issue probability models 213 comprises re-weighting one or more coefficients in a prediction algorithm.

If the step of predicting customer issues is deemed to have been made incorrectly, the method 200 continues with presenting the customer with an IVR wizard 214 that walks the customer through a plurality of menus 215 for narrowing down what issue the customer is calling about.

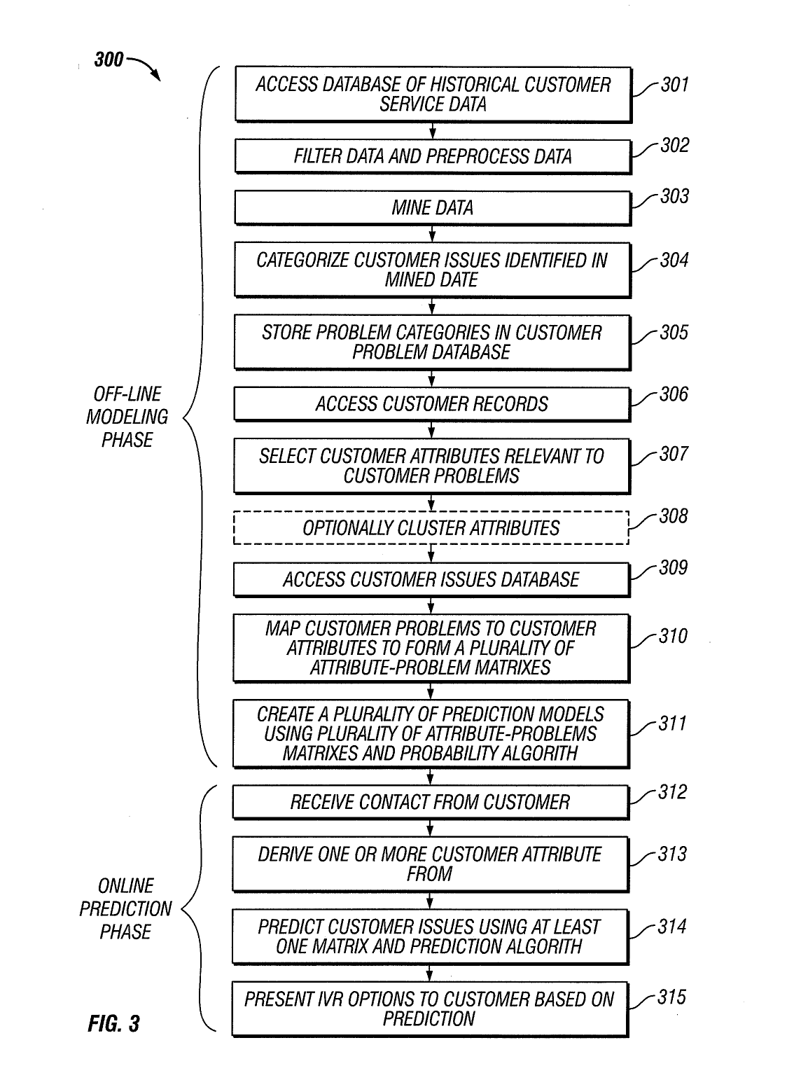

FIG. 3 is an alternate representation of a method of improving customer satisfaction 300 in an interactive voice response system according to some embodiments of the invention. The method 300 includes an off-line mode of gathering historical data and modeling a plurality of prediction models and an on-line mode of applying the plurality of prediction models to customer contacts.

The off-line modeling mode begins with accessing one or more database containing historical customer data 301. Next, the method continues as the historical customer data is filtered and pre-processed 302. The filtered and preprocessed data is then mined 303 for issues and attribute, as explained above. The mined data is categorized 304 and the identified customer issues are stored in one or more customer issue database 305.

Next, the customer records are accessed 306 and a plurality of attributes are selected from the customer records 307 that are relevant to the identified customer issues. In some embodiments, the customer attributes are clustered 308. Once the customer attributes are selected, the customer issue data is re-accessed 309 and the customer issues are mapped to the customer attributes to form one or more attribute-issue matrixes 310. Next, one or more issue prediction models are derived using the one or more attribute-issue matrixes and at least one probability algorithm 311.

Once one or more prediction models have been derived, the method 300 is ready for on-line application. The on-line portion of the method 300 begins when a customer makes contact with an IVR system 312. The IVR system extracts one or more customer attribute from the customer's contact. For example, the IVR system can extract information about customers 313 through analyzing their phone number, determining what kind of phone they are calling from, determining who there phone service provider is, determining what kind of calling plan they have, analyzing the time of day that they are calling, etc. Those with ordinary skill in the art having the benefit of this disclosure will readily appreciate that a computer system can learn a wide variety of information about callers explicitly or inductively using a wide range of technologies now known or later developed.

Next, the prediction engine in the IVR system uses the issues predictions models and the customer attributes to make one or more prediction about what issue the customer is calling about 314. Based on the one or more prediction, the IVR system presents the user with IVR options relevant to the predicted issue 315.

### Predictive Algorithm

The methods and systems explained above create prediction models using historical customer data with probability algorithms to predict future events. The following discussion will analyze how the systems and methods of the invention operate using a particular algorithm and operating in a particular customer service environment.

Specifically, the following discussion is a walkthrough of issue prediction for the caller of a customer service IVR system for a mobile phone carrier company, wherein the prediction models are assembled, at least in part, using the Naïve Bayes algorithm. It will be readily apparent to those with ordinary skill in the art having the benefit of reading this disclosure that a wide variety of probability algorithms can be employed to perform the prediction described herein for any number of customer service environments.

In some embodiments of the invention, a prediction engine is used in the IVR system of mobile phone carrier. As explained above, the prediction engine performs a modeling step to create a prediction model. The modeling steps uses historical data of customer attributes and maps those attributes to common customer service issues.

Table 1 represents a collection of mobile phone customer attribute definition data.

TABLE 1

| | |
|---|---|
| Attributes | Attribute Levels |

| | | | | |
|---|---|---|---|---|
| State | Arizona | Alabama | Wisconsin | Ohio |
| Plan | Family | Basic | Friends | empty |
| | Plan | Plan | | set |
| Handset Type | Nokia | Motorola | RIM | empty |
| | | | | set |

| | |
|---|---|
| Business Age | Continuous Numeric Values |
| (BznsAge) | |
| Days Left in | Continuous Numeric Values |
| Contract | |
| (Days_Left) | |

Using the data of Table 1, the prediction engine creates a matrix of historical customer service data for the listed attribute levels. Table 2 represents an example of a matrix of historical customer service data populated with customer attributes and customer service data. Query data in Table 2 is represented by “1” and “0” to indicate if the query had either been present or absent, respectively.

TABLE 2

| | Customer's | | | | | Queries from Text Mining | | | | | | | | |
|---|---|---|---|---|---|---|---|---|---|---|---|---|---|---|
| | Attributes | | | | | | | | | | War- | Acces- | Acti- | |
| ID | State | Plan | Handset | BznsAge | Days_Left | Signal | Battery | Screen | Access | CallDrop | ranty | sories | vation | Cancel |
| 1 | Arizona | Friends | Nokia | 245 | 123 | 0 | 1 | 1 | 1 | 0 | 1 | 0 | 1 | 0 |
| 2 | Alabama | Basic | Nokia | 324 | 234 | 0 | 1 | 0 | 1 | 1 | 0 | 0 | 1 | 1 |
| 3 | Alabama | Basic | Motorola | 254 | 245 | 0 | 1 | 0 | 0 | 1 | 1 | 0 | 1 | 1 |
| 4 | Wisconsin | Friends | RIM | 375 | 311 | 1 | 1 | 0 | 1 | 0 | 1 | 1 | 0 | 1 |
| 5 | Arizona | Family | Nokia | 134 | 153 | 0 | 0 | 0 | 1 | 1 | 1 | 1 | 0 | 1 |
| 6 | Alabama | Basic | Motorola | 234 | 134 | 1 | 1 | 0 | 1 | 1 | 1 | 0 | 1 | 1 |
| 7 | Ohio | Friends | Nokia | 296 | 217 | 1 | 1 | 1 | 0 | 1 | 0 | 1 | 1 | 0 |
| 8 | Ohio | Friends | Motorola | 311 | 301 | 1 | 1 | 1 | 0 | 1 | 0 | 1 | 1 | 1 |
| 9 | Ohio | Basic | RIM | 186 | 212 | 1 | 1 | 0 | 1 | 1 | 0 | 0 | 0 | 0 |
| 10 | Arizona | Family | Nokia | 276 | 129 | 1 | 0 | 1 | 1 | 0 | 1 | 0 | 1 | 1 |
| 11 | Wisconsin | Friends | Motorola | 309 | 187 | 1 | 0 | 1 | 1 | 1 | 1 | 0 | 0 | 0 |
| 12 | Arizona | Basic | Motorola | 244 | 156 | 0 | 0 | 0 | 0 | 0 | 1 | 1 | 0 | 1 |
| 13 | Alabama | Family | RIM | 111 | 256 | 0 | 1 | 0 | 1 | 1 | 1 | 1 | 0 | 1 |
| 14 | Arizona | Friends | RIM | 222 | 385 | 0 | 1 | 0 | 0 | 0 | 1 | 0 | 1 | 1 |
| 15 | Ohio | Family | Nokia | 268 | 134 | 0 | 0 | 0 | 1 | 0 | 0 | 1 | 1 | 0 |
| | | | | | Total | 7 | 10 | 5 | 10 | 9 | 10 | 7 | 9 | 10 |

| | |
|---|---|
| Grand Total | 77 |

The prediction engine of the IVR system uses the matrix of Table 2 along with a probability algorithm for predicting future issues of customer service. In some embodiments, it is particularly useful to use the Naïve Bayes algorithm for predicting future customer service issues, problems, queries, etc.

P(Q/A₁, . . . , Aₙ)=p(Q)p(A₁/Q)p(A₂/Q) . . . p(Aₙ/Q) Equation 1

Equation 1 above is used by an appropriately configured processor to calculate the conditional probability, P (Q/A₁, . . . , Aₙ). The probability of Query Q to be asked by the customer if he possesses the attributes A₁, . . . , Aₙ. To calculate this probability, we need values of the probabilities shown on the right side of the equation. The probability p (Q) and conditional probabilities p (Aᵢ/Q) can be calculated from the merged data matrix.

In Equation 1, p (Q) is calculated as the ratio of “number of times query Q appears in the matrix” to the “summation of number of times all the queries Q₁, . . . Qₙ occurring”, and p (Aᵢ/Q) is calculated differently for Categorical and Continuous data. Also, the probabilities for all Queries based on the attributes are calculated and top three problems, based on the value of probability are selected.

Using Equation 1, the prediction engine determines probability for incoming categorical data. For example, if a customer calls and it is determined that the customer has attributes (Arizona, Family, Nokia, 230, 120), the probability of an issue being a SIGNAL query can be calculated as follows:

p(Signal/Arizona, Family, Nokia, 230, 120=p(Signal)p(Arizona/Signal)p(Family/Signal)p(Nokia/Signal)p(BznsAge=230/Signal)p(DaysLeft=120/Signal) Equation 2

Therefore, p (Aᵢ/Q) can be calculated as the ratio of “number of times attribute Aᵢ appeared in all the cases when Query Q appeared” to the “number of times Query Q appeared”

Next, the prediction engine references the historical data. For example, the prediction engine looks at the Query Data of Table 2, but it only examines SIGNAL queries. Table 3 is a condensed version of Table 2 in which the prediction engine examines only SIGNAL queries.

TABLE 3

| | | | | | | Queries |
|---|---|---|---|---|---|---|
| | | | | | | from |
| | | | | | | Text |
| | Customer's Attributes | | | | | Mining |
| ID | State | Plan | Handset | BznsAge | Days_Left | Signal |
| 4 | Wisconsin | Friends | RIM | 375 | 311 | 1 |
| 6 | Alabama | Basic | Motorola | 234 | 134 | 1 |
| 7 | Ohio | Friends | Nokia | 296 | 217 | 1 |
| 8 | Ohio | Friends | Motorola | 311 | 301 | 1 |
| 9 | Ohio | Basic | RIM | 186 | 212 | 1 |
| 10 | Arizona | Family | Nokia | 276 | 129 | 1 |
| 11 | Wisconsin | Friends | Motorola | 309 | 187 | 1 |
| | | | | | Total | 7 |

The prediction engine uses the SIGNAL queries and consumer attributes of Table 3 with Equation 1 to yield a conditional probability. For example, a SIGNAL query appears seven times while there are a total of seventy-seven queries.

p(SIGNAL)=7/77 Equation 3

The prediction engine then determines how attributes relate to the conditional probability based on how the attributes contribute to the total conditional probability as follows:

p(Arizona/SIGNAL)=1/7 Equation 4

p(Family/SIGNAL)=1/7 Equation 5

p(Nokia/SIGNAL)=2/7 Equation 6

In a similar fashion Table 4 is a condensed version of Table 2, in which only the CANCEL queries are examined.

TABLE 4

| | | | | | | Queries |
|---|---|---|---|---|---|---|
| | | | | | | from |
| | | | | | | Text |
| | Customer's Attributes | | | | | Mining |
| ID | State | Plan | Handset | BznsAge | Days_Left | Cancel |
| 2 | Alabama | Basic | Nokia | 324 | 234 | 1 |
| 3 | Alabama | Basic | Motorola | 254 | 245 | 1 |
| 4 | Wisconsin | Friends | RIM | 375 | 311 | 1 |
| 5 | Arizona | Family | Nokia | 134 | 153 | 1 |
| 6 | Alabama | Basic | Motorola | 234 | 134 | 1 |
| 8 | Ohio | Friends | Motorola | 311 | 301 | 1 |
| 10 | Arizona | Family | Nokia | 276 | 129 | 1 |
| 12 | Arizona | Basic | Motorola | 244 | 156 | 1 |
| 13 | Alabama | Family | RIM | 111 | 256 | 1 |
| 14 | Arizona | Friends | RIM | 222 | 385 | 1 |
| | | | | | Total | 10 |

The prediction engine uses the CANCEL queries and consumer attributes of Table 4 with Equation 1 to yield another conditional probability. The CANCEL query appears ten times while there are a total of seventy-seven queries.

p(CANCEL)=10/77 Equation 7

The prediction engine then determines how attributes relate to the conditional probability based on how the attributes contribute to the total conditional probability as follows:

p(Arizona/CANCEL)=4/10 Equation 8

p(Family/CANCEL)=3/10 Equation 9

p(Nokia/CANCEL)=3/10 Equation 10

The prediction engine then populates these conditional probabilities into a matrix, to be used in final probability calculation. Table 5 is a matrix of conditional probabilities according to this working example.

TABLE 5

| | | | | | | | Call | | | | |
|---|---|---|---|---|---|---|---|---|---|---|---|
| | | | Signal | Battery | Screen | Access | Drop | Warranty | Accessories | Activation | Cancel |
| p (Query) | | | 7/77 | * | * | * | * | * | * | * | 10/77 |
| p (Attribute/Query) | | | | | | | | | | | |
| Arizona | | | 1/7 | * | * | * | * | * | * | * | 4/10 |
| Alabama | | | * | * | * | * | * | * | * | * | * |
| Wisconsin | | | * | * | * | * | * | * | * | * | * |
| Ohio | | | * | * | * | * | * | * | * | * | * |
| | Family | | 1/7 | * | * | * | * | * | * | * | 3/10 |
| | Basic | | * | * | * | * | * | * | * | * | * |
| | Friends | | * | * | * | * | * | * | * | * | * |
| | | Nokia | 2/7 | * | * | * | * | * | * | * | 3/10 |
| | | Motorola | * | * | * | * | * | * | * | * | * |
| | | RIM | * | * | * | * | * | * | * | * | * |

The cells in Table 5 which contain an asterisk “*” do not have a calculated probability in this document. In an actual calculation these would be populated as well.

The example above considered categorical data. In some embodiments of the invention, the prediction engine determines probability data for continuous numeric data. Assuming that the data is normally distributed, the probability density function is defined as:

Probability at a single point in any continuous distribution is zero. Probability for a small range of a continuous function can be calculated as follows:

$$f ( x ) = \frac{1}{2 π \sqrt{σ}} {e}^{\frac{{( x - μ )}^{2}}{2 {σ}^{2}}} \qquad Equation 11$$

Treating this as the probability for a particular value, we can neglect ΔX because this term appears in all the probabilities calculated for each Query/Problem. Hence, we use the density function f(X) as the probability, which we can calculate for a particular numeric value X from its formula.

This mean (μ) and standard (σ) for the assumed normal distribution can be calculated as per the following formulae:

$$\begin{matrix}μ = \frac{1}{n} ( {\sum }_{i = 1}^{n} {X}_{i} ) & Equation 12 \\ σ = \sqrt{\frac{1}{n - 1} ( {\sum }_{i = 1}^{n} {( {X}_{i} - μ )}^{2} )} & Equation 13\end{matrix}$$

For SIGNAL issues, the mean and the standard deviation for Business Age (BznsAge) can be calculated using the above formulas as follows:

$${μ}_{BznsAge} = \frac{( 375 + 234 + 296 + 311 + 186 + 276 + 309 )}{7}$$

$${μ}_{BznsAge} = 283.85$$

$${σ}_{BznsAge} = \frac{1}{6} ( \begin{matrix}{( 375 - 283.85 )}^{2} + {( 234 - 283.85 )}^{2} + \\ \begin{matrix}{( 296 - 283.85 )}^{2} + {( 311 - 283.85 )}^{2} + \\ \begin{matrix}{( 186 - 283.85 )}^{2} + {( 276 - 283.85 )}^{2} + \\ {( 309 - 283.85 )}^{2}\end{matrix}\end{matrix}\end{matrix} )$$

$${σ}_{BznsAge} = 60.47$$

$$p ( BznsAge = 230 / Signal ) = \frac{1}{2 π \sqrt{60.47}} {e}^{\frac{{( 230 - 283.85 )}^{2}}{{60.47}^{2}}} \\ p ( BznsAge = 230 / Signal ) = 0.029169 \\ Similarly for Days\_Left , \\ {μ}_{DaysLeft} = 213$$

$${σ}_{DaysLeft} = 72.27$$

$$p ( DaysLeft = 120 / Signal ) = 0.04289$$

For the CANCEL query, the mean and standard deviation for BznsAge and Days_Left can be calculated in similar fashion as follows:

μ_{BznsAge}=248.5

σ_{BznsAge}=81.2

p(BznsAge=230/Cancel)=0.018136

μ_{DaysLeft}=230.4

σ_{DaysLeft}=86.51

p(DaysLeft=120/Cancel)=0.03867

These probabilities are calculated by the prediction engine in real time, with the exact value of the attribute the customer possesses. We can populate a matrix with the Mean and a Standard Deviation computed for use for the probability calculation in real time. Table 6 is a matrix of Means and Standard Deviations for call issues based and customer attributes.

TABLE 6

| | | Signal | Battery | Screen | Access | CallDrop | Warranty | Accessories | Activation | Cancel |
|---|---|---|---|---|---|---|---|---|---|---|
| BznsAge | Mean(mu) | 283.85 | * | * | * | * | * | * | * | 248.5 |
| | Standard | 60.47 | * | * | * | * | * | * | * | 81.2 |
| | Deviation | | | | | | | | | |
| | (sigma) | | | | | | | | | |
| Days_Left | Mean(mu) | 213 | * | * | * | * | * | * | * | 230.4 |
| | Standard | 72.27 | * | * | * | * | * | * | * | 86.51 |
| | Deviation | | | | | | | | | |
| | (sigma) | | | | | | | | | |

Next, the prediction engine calculates the final probability for a query/problem for the given set of customer attributes. For example, the prediction engine calculates probabilities using the information from the above example as follows:

p(SIGNAL/Arizona, Family, Nokia, 230, 120)=(7/77)*(1/7)*(1/7)*(2/7)*0.029169*0.4289 Equation 14

p(SIGNAL/Arizona, Family, Nokia, 230, 120)=0.0000006632 Equation 15

p(CANCEL/Arizona, Family, Nokia, 230, 120)=(10/77)*(4/10)*(3/10)*(3/10)*0.018136*0.03867 Equation 16

p(CANCEL/Arizona, Family, Nokia, 230, 120)=0.0000032789 Equation 17

The prediction engine uses the probabilities of all the queries/problems for all given attributes. The prediction engine normalizes the probabilities and selects a given number of the top probabilities and the queries/problems corresponding to the top probabilities. For example, the prediction may select the top three probabilities. The prediction engine then determines which query/problem has a higher probability to occur.

Using the data from the above example, the prediction engine normalizes the data set as follows:

p(SIGNAL/Arizona, Family, Nokia, 230, 120)=(0.0000006632/0.0000006632+0.0000032789)*100 Equation 18

p(SIGNAL/Arizona, Family, Nokia, 230, 120)=83.17% Equation 19

p(CANCEL/Arizona, Family, Nokia, 230, 120)=(0.0000032789/0.0000006632+0.0000032789)*100 Equation 20

p(CANCEL/Arizona, Family, Nokia, 230, 120)=16.83% Equation 21

Therefore, the prediction determines that the SIGNAL problem has a significantly high probability of occurrence relative to the CANCEL problem.

In some embodiments of the invention, a Laplace Estimator function accounts for conditional probabilities that are zero. A Laplace transform is an integral transform that simplifies the process of analyzing the behavior of the system, or in synthesizing a new system based on a set of specifications.

For example, it is not appropriate to use zero values because they make the product of the probabilities equal to zero. We account for this problem using the following equation:

$$p ( {A}_{i} / Q ) = \frac{x}{y} ; if x = 0 ; p ( {A}_{i} / Q ) = 0 , \qquad Equation 22$$

wherein χ=number of time Aᵢ occurred when Q occurred y times;
wherein y=number of times Q occurred; and
wherein n=number of queries/problems used.

To avoid the above-mentioned zero-value problem, the prediction engine uses the Laplace Estimator as show below:

$$p ( {A}_{i} / Q ) = ( \frac{x + 1}{y + n} ) , \qquad Equation 23$$

wherein 1/n is the prior probability of any query/problem.

Therefore, if the prediction engine does not have the x and y values, 1/n is the probability. Therefore, even if X is equal to zero, the conditional probability has some value.

### Customer Service Web Interface and Chat Issue Prediction

Some embodiments of the invention are extended to other communication channels, such as web-chat, instant messaging, voice over internet protocol (VoIP), mobile device communication formats (i.e. SMS, MMS, etc.), and other communication channels, now known or later developed. In any communication environment, the predictive engine provides the same type of useful information to customer service agencies as in the IVR system.

In the case of web-chat, the predictive engine delivers useful information to a customer service agency for providing web-based issue resolution. In some embodiments of the invention, when a customer is browsing a customer service page, a proactive chat invitation can pop up if the prediction engine determines that the customer is in need of assistance. According to these embodiments, a customer may engage in an interactive browser-based chat exchange with a live customer service agent.

According to the web-based embodiments, the predictive engine delivers useful information to a customer service agency for providing web-based issue resolution. In some embodiments of the invention, a prediction engine gathers customer attributes via an internet protocol and predicts customer service issues automatically.

As explained above, in some embodiments of the invention, the prediction engine delivers a chat invitation to the customer along with providing the customer service agent with tools for resolving predicted customer issues. In some other embodiments, the results of this prediction are passed on to the chat customer service agent to help the agent identify the most likely reasons for customer contact, thereby increasing the agent's productivity. In another scenario, the prediction engine provides the customer service agent with pre-scripted resolutions to the predicted issues. In yet other embodiments, the prediction results gives customer service agents access to an intelligent knowledge database containing relevant tools to assist the agent in resolving the customer's issues.

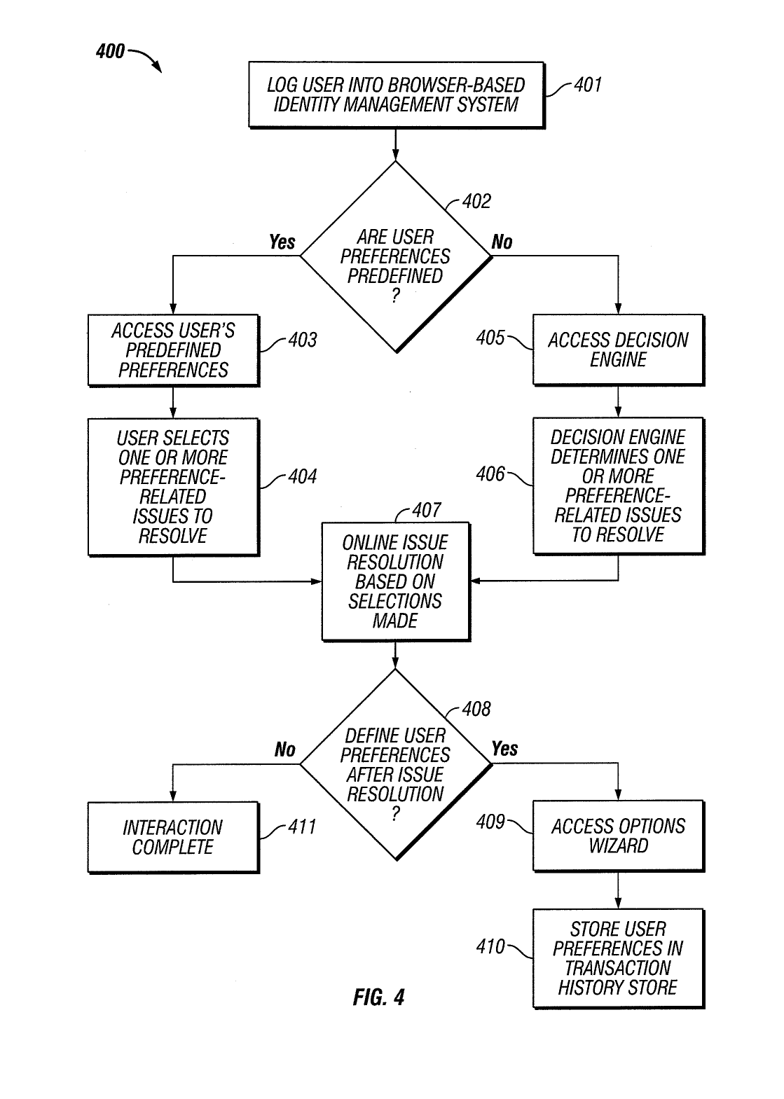

In the web-based embodiments of the invention, a decision engine is employed in a web-accessed customer service response system. According to these embodiments, the web-accessed customer service response system uses a decision engine to determine and predict customer service issues, queries, and problems. The decision operates in a similar fashion with the IVR prediction engine explained above. FIG. 4 illustrates a method 400 of web-accessed customer service using a decision engine according to some embodiments of the invention.

The method 400 of web-accessed customer service begins as a user logs into a browser-based identity management system 401. The system determines whether that user's preferences are pre-defined 402. If the user's preferences are predefined, the user's preferences are accessed 403 and the user selects one or more preference-related issue, query, or problem to resolve 404.

If the user's preferences are not predefined, the method 400 continues by accessing a decision engine 405. The decision engine determines one or more preference-related issue, query, or problem to resolve 406.

Once one or more problem, issue, or query is identified, the method 400 continues by on-line resolution of the problem, issue, or query 407. Next, the user decides whether to store his preferences after resolution for later use 408. If so, the method accesses an options wizard 409 and stores user preferences in a user transaction history store 410. Optionally, the preferences are also stored in a user-agnostic community transaction data store. If the user does not want his preferences stored, the interaction completes 411.

### Computer Architecture for Carrying Out the Invention

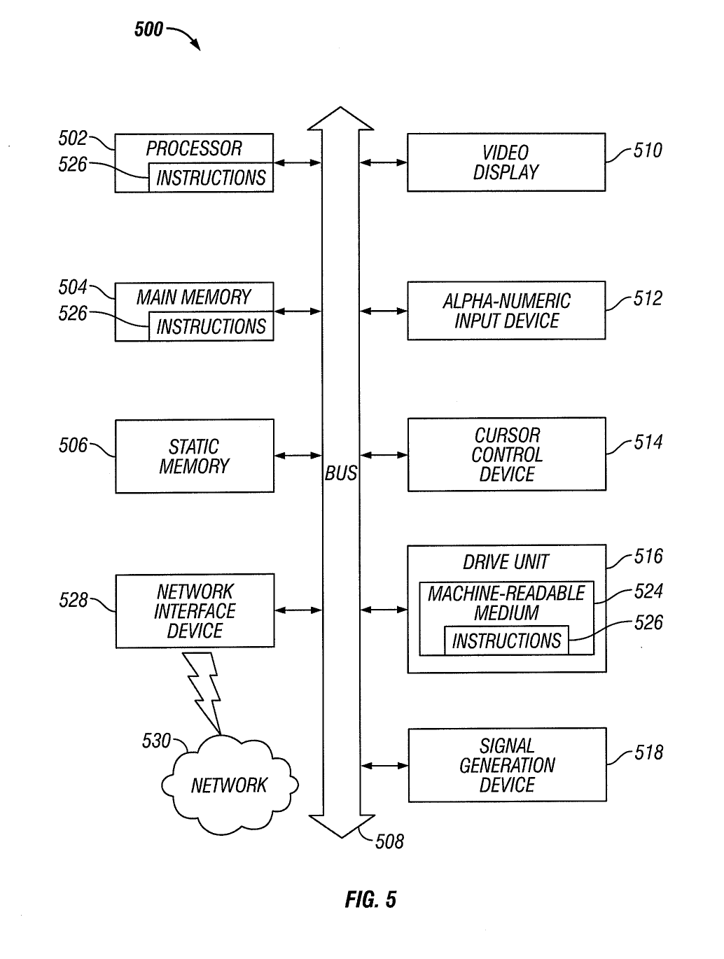

FIG. 5 is a block schematic diagram of a machine in the exemplary form of a computer system 500 within which a set of instructions may be programmed to cause the machine to execute the logic steps of the invention. In alternative embodiments, the machine may comprise a network router, a network switch, a network bridge, personal digital assistant (PDA), a cellular telephone, a Web appliance or any machine capable of executing a sequence of instructions that specify actions to be taken by that machine.

The computer system 500 includes a processor 502, a main memory 504 and a static memory 506, which communicate with each other via a bus 508. The computer system 500 may further include a display unit 510, for example, a liquid crystal display (LCD) or a cathode ray tube (CRT). The computer system 500 also includes an alphanumeric input device 512, for example, a keyboard; a cursor control device 514, for example, a mouse; a disk drive unit 516, a signal generation device 518, for example, a speaker, and a network interface device 520.

The disk drive unit 516 includes a machine-readable medium 524 on which is stored a set of executable instructions, i.e. software, 526 embodying any one, or all, of the methodologies described herein below. The software 526 is also shown to reside, completely or at least partially, within the main memory 504 and/or within the processor 502. The software 526 may further be transmitted or received over a network 528, 530 by means of a network interface device 520.

In contrast to the system 500 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complimentary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention described herein with reference to the preferred embodiments, one skilled in the art will readily appreciate that other applications may be substituted for those set forth herein without departing from the spirit and scope of the invention. Accordingly, the invention should only be limited by the Claims included below.

1. A computer-implemented method for predicting customer service issues in an interactive voice response system, comprising the steps of:
providing a processor configured for creating at least one model of customer service issue probability by data mining at least one source of historical customer service records;
said processor configured for establishing an interactive voice response communication session between an interactive voice response system and at least one customer on an auditory communication channel;
said processor configured for receiving at least one customer attribute from at least one customer during said interactive voice response session;
said processor configured for accessing said at least one model of customer service issue probability;
said processor configured for predicting one or more response options using said at least one model of customer service issue probability and said at least one customer attribute; and
said processor configured for presenting interactive voice response options to said at least one customer.

2. The method of claim 1, wherein said auditory communication channel is selected from among any of telephonic communication channels, voice over internet protocol communication channels, and browser-based direct-link audio chat communication channels.

3. The method of claim 1, wherein said at least one source is selected from among any of:
structured textual customer service records;
unstructured textual customer service records;
raw customer-agent voice interaction data;
processed customer-agent voice interaction data in the form of converted voice to text;
text chat data sent by customers via a browser-based instant messaging protocol; and
text message data sent by customers via a mobile device.

4. The method of claim 3, further comprising the step of said processor configured for pre-processing said raw customer-agent interaction data by performing a voice-data to text-data conversion.

5. The method of claim 1, further comprising the step of:
said processor configured for determining if said attribute prediction correctly identified an issue of said at least one customer.

6. The method of claim 5, wherein said determination of whether said issue prediction correctly identified an issue of said at least one customer is performed by said interactive voice response system by explicitly asking said at least one customer if said issue prediction was correct during said interactive voice response session.

7. The method of claim 5, wherein said determination of whether said issue prediction correctly identified an issue of said at least one customer is performed implicitly by inferring that said issue prediction was correct when said at least one customer continues said interactive voice response session after being presented with said interactive voice response options based on said issue prediction.

8. The method of claim 5, further comprising the steps of:
said processor configured for creating a plurality of models of customer service issue probability;
said processor configured for clustering said plurality of models of customer service issue probability in the form of a clustered model; and
said processor configured for assigning a weighted coefficient to each of the models of customer service issue probability within said clustered model based on their relative ability to correctly predict customer issues.

9. The method of claim 8, further comprising the steps of:
said processor configured for updating said predictive model by re-weighting said coefficients each time an issue prediction is made such that models yielding false predictions are demoted and models yielding true predictions are promoted.

10. The method of claim 5, further comprising the step of:
said processor for presenting said at least one customer at least one additional set of interactive voice response options upon determining that said issue prediction incorrectly identified an issue of said at least one customer.

11. The method of claim 5, further comprising the step of:
said processor configured for presenting said at least one customer an interactive voice response options wizard upon determining that said issue prediction incorrectly identified an issue of said at least one customer.

12. The method of claim 1, wherein the step of creating at least one model of customer service issue probability further comprises the steps of:
said processor configured for accessing historical customer interaction data;
said processor configured for preprocessing said historical customer data into a text format history data;
said processor configured for data-mining text format history data to identify customer issues;
said processor configured for categorizing customer issues;
said processor configured for storing issue categories in an issue database;
said processor configured for accessing customer attribute data;
said processor configured for mapping customer attribute data to customer issues to form one or more attribute-issue matrixes; and
said processor configured for applying a probability algorithm to said one or more attribute-issue matrixes to determine the probability that a particular issue will arise when a particular attribute is present.

13. The method of claim 12, wherein a Naïve Bayes Algorithm is applied to said one or more attribute-issue matrixes.

14. The method of claim 1, wherein the step of receiving at least one customer attribute from at least one customer during said interactive voice response session is accomplished using any of the one or more steps of:
said processor configured for analyzing an explicit attribute associated with said at least one customer; and
said processor configured for predicting a probable attribute of said at least one customer in the form of an attribute prediction.

15. A system for predicting customer service issues, comprising:
a database containing at least one model of customer service issue probability by data mining at least one source of historical customer service records;
an interactive voice response (IVR) communication system for performing an IVR session between a customer service agency and at least one customer on an auditory communication channel;
wherein the IVR communication system comprises a voice detection unit for deriving at least one customer attribute from at least one customer during said IVR session;
wherein the IVR communication system further comprises a processor configured to:
access said at least one model of customer service issue probability and predict response options based on said at least one customer attribute; and
present interactive voice response options to said at least one customer.

16. The system of claim 15, wherein said auditory communication channel is selected from any of telephonic communication channels, voice over internet protocol communication channels, and browser-based direct-link audio chat communication channels.

17. The system of claim 15, further comprising:
means for determining if said attribute prediction correctly identified an issue of said at least one customer.

18. The system of claim 17, further comprising:
means for creating a plurality of models of customer service issue probability; and
means assigning a weighted coefficient to each of the models of customer service issue probability within said plurality of models based on their relative ability to correctly predict customer issues.

19. The system of claim 18, further comprising:
means for updating said clustered model by re-weighting said coefficients each time an issue prediction is made such that models yielding false predictions are demoted and models yielding true predictions are promoted.

20. The system of claim 15, wherein the means for creating at least one model of customer service issue probability comprises:
means for accessing historical customer interaction data;
means for preprocessing said historical customer data into a text format history data;
means for data-mining text format history data to identify customer issues;
means for categorizing customer issues;
means for storing issue categories in an issue database;
means for accessing customer attribute data;
means for mapping customer attribute data to customer issues to form one or more attribute-issue matrixes; and
means for applying a probability algorithm to said one or more attribute-issue matrixes to determine the probability that a particular issue will arise when a particular attribute is present.

21. The system of claim 20, wherein a Naïve Bayes algorithm is applied to said one or more attribute-issue matrixes.

22. The system of claim 15, wherein said voice detection unit for deriving at least one customer attribute from at least one customer during said IVR session derives said at least one customer attribute using means selected from among:
means for analyzing an explicit attribute associated with said at least one customer;
means for predicting a probable attribute of said at least one customer in the form of an attribute prediction; and
combinations of means for analyzing explicit attributes and means for predicting probable attributes of said at least one customer.

23. A computer-readable medium containing instructions which, when executed by a processor, implements the method of claim 1.

24. A computer-implemented method for predicting customer service issues in a communication system, comprising the steps of:
providing a processor configured for creating at least one model of customer service issue probability by data mining at least one source of historical customer service records;
said processor configured for establishing an interactive communication session between an interactive communication system and at least one customer over a communication channel;
said processor configured for receiving at least one customer attribute from at least one customer during said interactive communication session;
said processor configured for accessing said at least one model of customer service issue probability;
said processor configured for predicting one or more response options using said at least one model of customer service issue probability and said at least one customer attribute; and
said processor configured for presenting interactive options to said at least one customer.

25. The method of claim 24, wherein said communication channel is selected from among any of a group of channels consisting of terrestrial telephonic communication channels, mobile telephonic channels, mobile device text messaging formats, mobile device media exchange formats, voice over internet protocol (VoIP), browser-based web-chat communications, and instant messaging protocol.
